(19) United States
(12) Patent Application Publication
(10) Pub. No.: US 2021/0254401 A1
(43) Pub. Date: Aug. 19, 2021

(54) USER-MOUNTABLE WINDOW-BLIND BOTTOM RAIL AND WINDOW BLIND USING THE SAME

(71) Applicant: CHING FENG HOME FASHIONS CO., LTD., FUXING TOWNSHIP (TW)

(72) Inventor: Wen-Ying LIANG, FUXING TOWNSHIP (TW)

(73) Assignee: CHING FENG HOME FASHIONS CO., LTD., FUXING TOWNSHIP (TW)

(21) Appl. No.: 16/808,080

(22) Filed: Mar. 3, 2020

(30) Foreign Application Priority Data
Feb. 13, 2020 (TW) 109201544

(51) Int. Cl. E06B 9/323; E06B 9/388; E06B 9/386

(52) U.S. Cl. CPC E06B 9/323; E06B 9/322; E06B 9/386; E06B 9/388

(57) ABSTRACT

A window blind includes: a headrail; a blind body and a cord reel, both mounted on the bottom wall of the headrail; two lift cords each having one end fixedly provided at the cord reel and the opposite end inserted through the headrail and the blind body and then fixed to the lower end of the blind body; and a weight and a bottom rail, both provided at the lower end of the blind body. The weight and a slat of the blind body are mounted into the bottom rail through either of the lengthwise ends of the bottom rail and are thus received in the bottom rail, with the junction between the slat and the other slats exposed through a mounting aperture of the bottom rail. The bottom rail can be mounted as needed to enable stable expansion and retraction of the window blind.

### BACKGROUND OF THE INVENTION

### 1. Technical Field

The present invention relates to a window blind and more particularly to a user-mountable window-blind bottom rail.

### 2. Description of Related Art

Referring to FIG. 1, a window blind 90 without an exposed pull string generally works in the following manner. The cord reel in the headrail 91 serves to reel in a left lift cord and a right lift cord. Each of the left and right lift cords has one end passing through the blind body 92 and locked to the bottom rail 94 by a locking member 93 so that the blind body 92 can be gradually lowered (i.e., expanded) or raised (i.e., retracted) by a user pulling down or pushing up the bottom rail 94.

As it is required to pull or push the bottom rail 94 in order to expand or retract the blind body 92, the bottom rail 94 may separate from the blind body 92 if the force applied to pull or push the bottom rail 94 is not properly exerted. Should that happen, the entire window blind 90 will have to be discarded and replaced by a new one, which nevertheless causes inconvenience to the user.

### BRIEF SUMMARY OF THE INVENTION

The primary objective of the present invention is to provide a window-blind bottom rail that can be mounted to the blind body of a window blind without an exposed pull string by the user of the window blind themselves. The invention aims to provide a technical means that not only allows a window-blind bottom rail to be mounted according to practical needs, but also produces the technical effect of enabling stable expansion and retraction of a window blind without an exposed pull string.

To achieve the above primary objective, the present invention provides a window blind that includes a headrail, a blind body, a cord reel, two lift cords, a weight, and a bottom rail. The headrail has a bottom wall with two through holes, wherein each through hole opens on the top and bottom surfaces of the bottom wall. The blind body has a first end mounted on the bottom surface of the bottom wall of the headrail. The cord reel is mounted on the top surface of the bottom wall of the headrail. Each of the two lift cords has one end fixedly provided at the cord reel. The opposite end of each lift cord is wound along a predetermined path and then inserted through the through holes of the headrail and the blind body, before being fixed to the opposite, or second, end of the blind body by a cord fixing member. The weight is provided at the second end of the blind body, and so is the bottom rail.

According to the present invention, the bottom rail includes a frame base, two frame sidewalls, and two frame stop walls. The frame sidewalls extend respectively from two opposite lengthwise sides of the frame base in a direction away from the frame base. The frame stop walls extend respectively from the upper ends of the frame sidewalls toward each other. The frame base and the two frame sidewalls define a receiving space therebetween. Each of the two frame stop walls has a free end, and the two free ends are spaced apart and define a mounting aperture therebetween, wherein the mounting aperture is in communication with the receiving space. In addition, the free end of each frame stop wall is formed with a blocking member projecting toward the frame base. The extension length of one of the frame stop walls is defined as L₁, while the extension length of the other frame stop wall is defined as L₂. The two extension lengths satisfy the relation of L₁:L₂=1:1˜3. The weight, which is mounted at the second end of the blind body, is mounted into the bottom rail through the opening at either of the lengthwise ends (i.e., the left or right end opening) of the bottom rail along with at least one slat or cell of the blind body such that the weight and the at least one slat or cell of the blind body are received in the receiving space of the bottom rail and, in the meantime, the junction between the at least one slat or cell and the other slats or cells of the blind body is exposed through the mounting aperture of the bottom rail.

The structural details, features, assembly methods, and methods of use of the bottom rail provided in the present invention for use in a window blind and of a window blind using the bottom rail will be described below. As a person of ordinary skill in the art would understand, the following detailed description and the specific embodiments provided herein serve illustrative purposes only and are not intended to be restrictive of the scope of the invention.

### BRIEF DESCRIPTION OF THE SEVERAL VIEWS OF THE DRAWINGS

FIG. 1 is a perspective view of a conventional window blind without an exposed pull string.

FIG. 2 is a perspective view of the window blind without an exposed pull string according to the first embodiment of the present invention, with the cells of the window blind in a retracted state.

FIG. 3 is a partially exploded perspective view of the window blind in FIG. 2.

FIG. 4 is a side view of certain components of the window blind in FIG. 2, with the cells of the window blind staying in the retracted state.

FIG. 5 is a perspective view of the bottom rail in FIG. 2.

FIG. 6 is similar to FIG. 4 except that the cells are expanded and that more cells are mounted in the bottom rail.

FIG. 7 is a top view of the bottom rail in FIG. 5, showing in particular the 1:1 relation between the extension lengths of the two frame stop walls of the bottom rail.

FIG. 8 is similar to FIG. 7 except that the relation between the extension lengths of the two frame stop walls of the bottom rail is changed to 1:3.

FIG. 9 is a side view of certain components of the window blind without an exposed pull string according to the second embodiment of the invention, with the cells of the window blind in an expanded state.

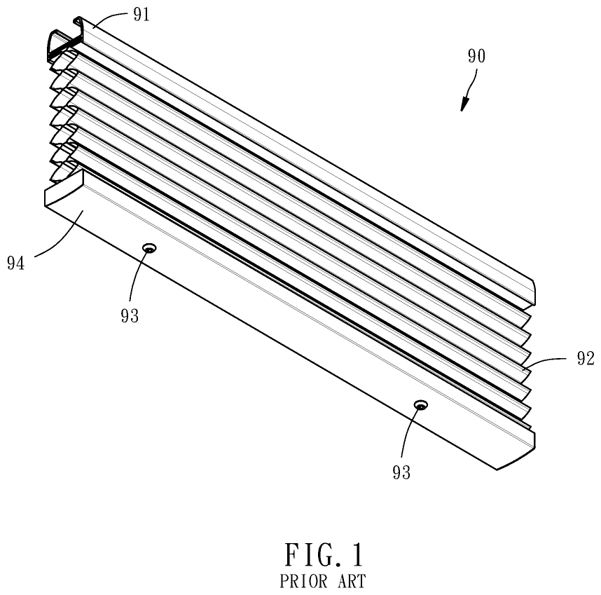

### DETAILED DESCRIPTION OF THE INVENTION

To begin with, the applicant of the present invention wishes to point out that all the directional terms used in this specification (including the following description of embodiments) and the appended claims make reference to the directions in the accompanying drawings. In addition, the same reference numeral is used for the same or similar elements or structural features throughout the embodiments described below and the accompanying drawings.

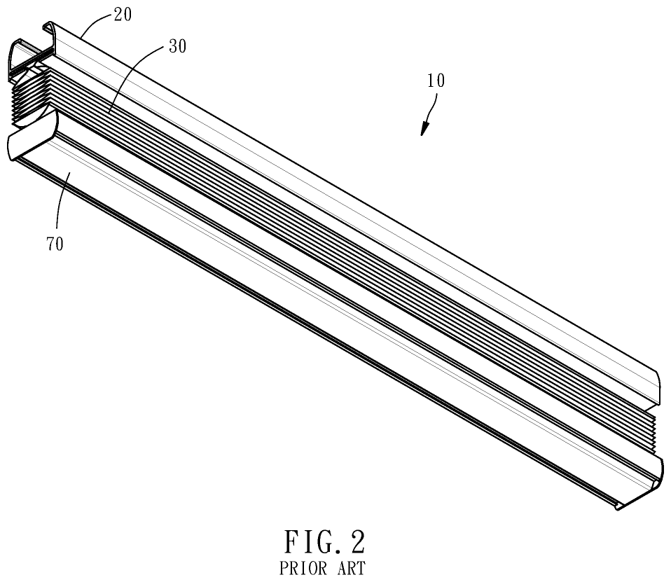

Referring to FIG. 2 to FIG. 5, the window blind 10 without an exposed pull string according to the first embodiment of the present invention includes a headrail 20, a blind body 30, a cord reel 40, two lift cords 50, a weight 60, and a bottom rail 70.

The headrail 20 has a bottom wall 21. The bottom wall 21 has two through holes 23, and each through hole 23 opens on the top surface and the bottom surface of the bottom wall 21.

The blind body 30 in this embodiment is a honeycomb blind by way of example; in other embodiments, the blind body 30 need not be so configured. A first end of the blind body 30 is mounted on the bottom surface of the bottom wall 21 of the headrail 20. The opposite, or second, end of the blind body 30 is mounted in the bottom rail 70.

The cord reel 40 is mounted on the top surface of the bottom wall 21 of the headrail 20.

Each of the two lift cords 50 has one end fixedly provided in the cord reel 40. The opposite end of each lift cord 50 is wound along a predetermined path, then inserted through the through holes 23 of the headrail 20 and the blind body 30, and then fixed to the second end of the blind body 30 by a cord fixing member 51, in order for the two lift cords 50 to work simultaneously.

The weight 60 is attached to the second end of the blind body 30 via an attaching member 61, which in this embodiment is a velcro, or a hook-and-loop fastener, by way of example; the present invention has no limitation on the type or configuration of the attaching member. Preferably, the attaching member 61 for the weight 60 lies between the two lift cords 51 to produce the technical effect of balancing the blind body 30.

The headrail 20, the blind body 30, the cord reel 40, the lift cords 50, and the weight 60 of the window blind 10 without an exposed pull string are well known in the art and do not constitute technical features of the present invention. For the sake of brevity, therefore, the foregoing components will not be described in more detail herein.

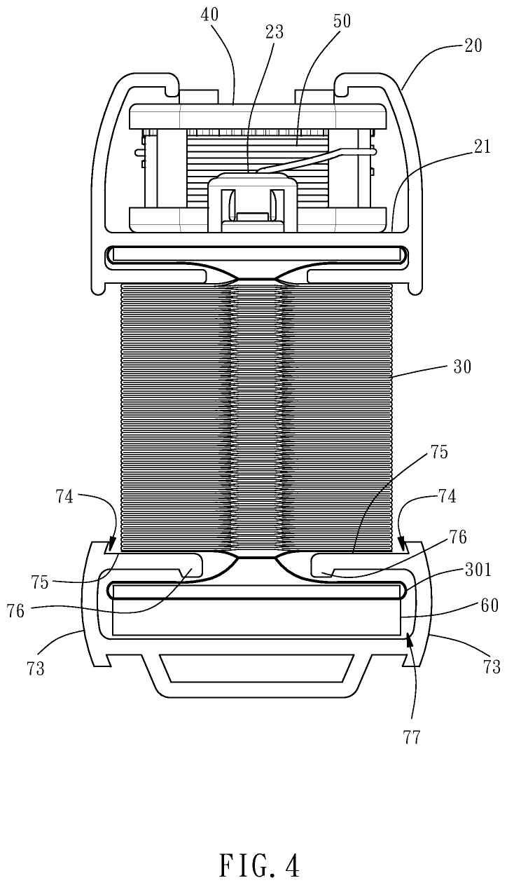

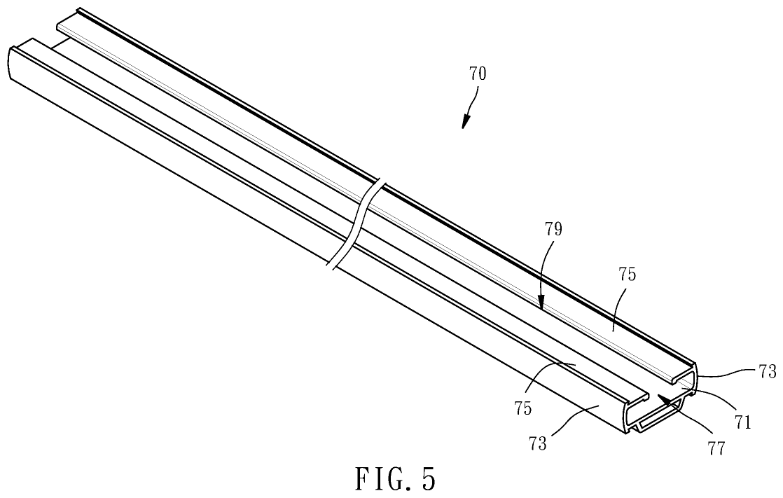

In the first embodiment of the present invention, referring to FIG. 4 and FIG. 5, the bottom rail 70 is a frame that extends lengthwise in the left-right direction and whose cross section has a generally C shape. The bottom rail 70 has a frame base 71, two frame sidewalls 73, and two frame stop walls 75. The frame sidewalls 73 extend upward respectively from the two opposite lengthwise sides of the frame base 71 in the same direction away from the frame base 71. The frame stop walls 75 extend respectively from the upper ends of the frame sidewalls 73 toward each other. The frame base 71 and the two frame sidewalls 73 surround and jointly define a receiving space 77. The free ends of the two frame stop walls 75 are spaced apart and define a mounting aperture 79 therebetween. The mounting aperture 79 is in communication with the receiving space 77, corresponds in position to the frame base 71, and extends lengthwise in the left-right direction. In addition, the junction between each frame sidewall 73 and the frame stop wall 75 connected thereto is formed with a position-limiting recess 74 for limiting the position of, and receiving, the second end of the blind body 30. Moreover, the free end of each frame stop wall 75 is formed with a blocking member 76 projecting toward the frame base 71.

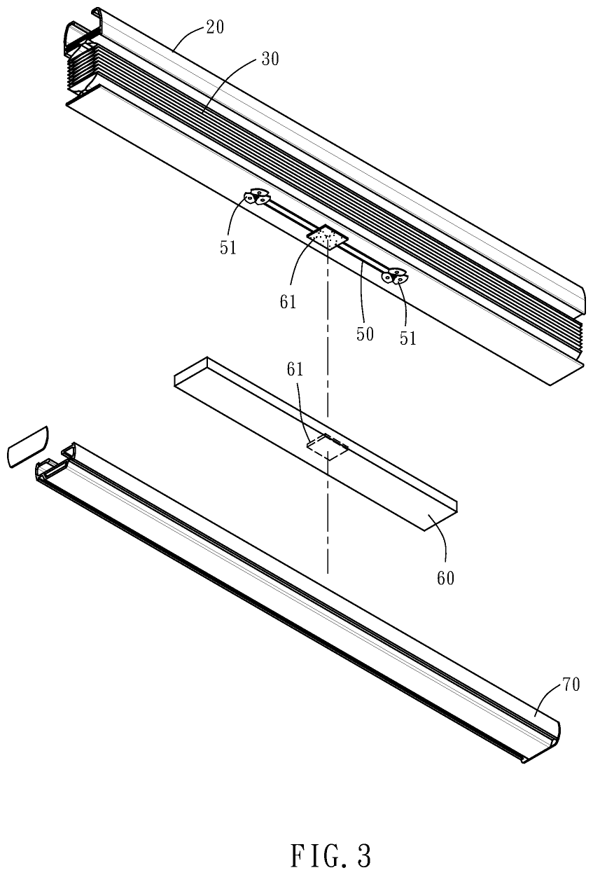

The bottom rail 70 of the window blind 10 without an exposed pull string as disclosed in the first embodiment of the present invention is mounted in the following manner. Referring to FIG. 3 to FIG. 5, the weight 60, which is mounted at the second end of the blind body 30 in advance, and at least one cell 301 of the blind body 30 are mounted into the bottom rail 70 through the opening at either of the lengthwise ends (i.e., the left or right end opening) of the bottom rail 70 and are therefore simultaneously received in the receiving space 77 of the bottom rail 70, with the junction between the at least one cell 301 and the other cells 301 of the blind body 30 exposed through the mounting aperture 79 of the bottom rail 70. Preferably, the at least one cell 301 and the other cells 301 of the blind body 30 are separated by the two frame stop walls 75 of the bottom rail 70 and end up on the top side and the bottom side of the two frame stop walls 75 respectively. Once the aforesaid mounting operation is completed, the bottom rail 70 of the window blind 10 without an exposed pull string is put in place (that is to say, the technical effect of making the bottom rail 70 user-mountable is achieved) and can be pulled or pushed to expand or retract the blind body 30.

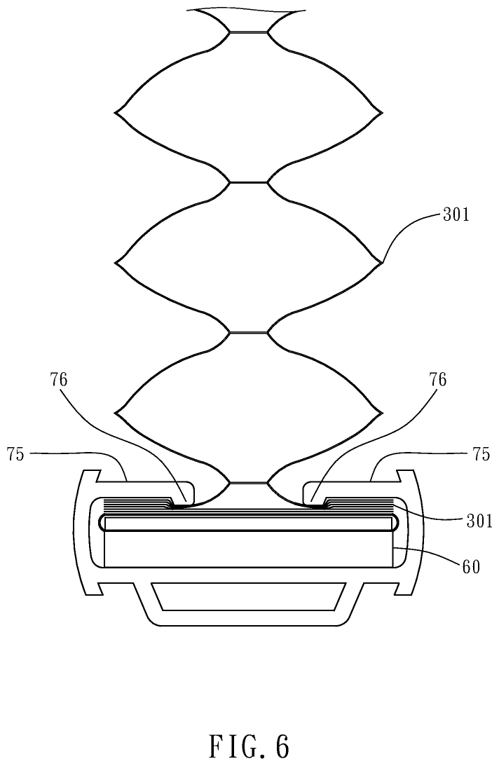

Referring to FIG. 6, the first embodiment of the present invention also allows a plurality of cells 301 of the blind body 30 (the number of which cells 301 can be determined according to practical needs, such as five as shown in this embodiment, although two, three, four, six, or a greater number is also feasible; the invention has no limitation in this regard) to be pressed together and then mounted along with the weight 60 into the bottom rail 70 through the opening at either of the lengthwise ends (i.e., the left or right end opening) of the bottom rail 70 so that the total weight of the bottom rail 70 can be significantly increased. Besides, not only do the two frame stop walls 75 of the bottom rail 70 serve as a separating component, but also the blocking members 76 at the free ends of the two frame stop walls 75 of the bottom rail 70 can produce the technical effect of blocking, and holding in place, the plural cells 301 of the blind body 30 that are received in the bottom rail 70.

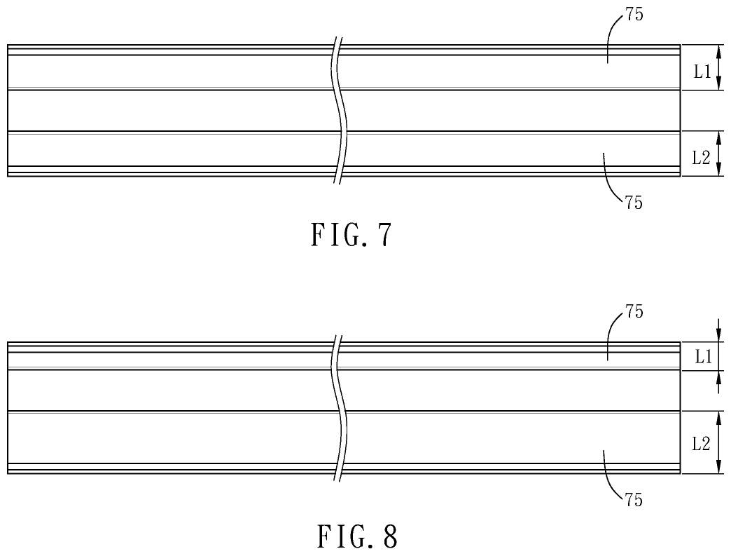

In the first embodiment of the present invention, referring to FIG. 7, the extension lengths of the two frame stop walls 75 of the bottom rail 70 satisfy the relation of L₁:L₂=1:1, where L₁ is the length for which one of the frame stop walls 75 extends from the corresponding frame sidewall 73 and L₂ is the length for which the other frame stop wall 75 extends from the corresponding frame sidewall 73. It is worth mentioning that, depending on practical needs, the extension lengths of the two frame stop walls 75 of the bottom rail 70 may satisfy the relation of L₁:L₂=1:3 instead, as shown in FIG. 8.

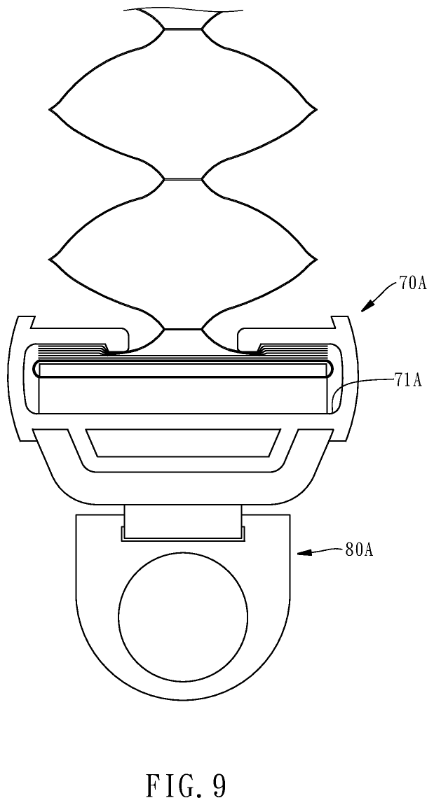

FIG. 9 shows the bottom rail 70A of the user-mountable window blind without an exposed pull string according to the second embodiment of the present invention. The main structure, technical features, and intended technical effects of this window blind are the same as those of the window blind in the first embodiment and, for the sake of brevity therefore, will not be described repeatedly. The second embodiment is different from the first embodiment in that the outer wall of the frame base 71A of the bottom rail 70A is mounted with a pull ring 80A to be pulled or pushed by the user, thus producing the technical effect of making it easier for the user to apply a force to the bottom rail 70A.

What is claimed is:

1. A bottom rail of a window blind, comprising:
a frame base, two frame sidewalls, and two frame stop walls, wherein the frame sidewalls extend respectively from two opposite lengthwise sides of the frame base in a direction away from the frame base, and the frame stop walls extend respectively from upper ends of the frame sidewalls toward each other;
wherein the frame base and the two frame sidewalls define a receiving space therebetween, each of the two frame stop walls has a free end, the free ends of the two frame stop walls are spaced apart and define a mounting aperture therebetween, the mounting aperture is in communication with the receiving space, and the free end of each of the frame stop walls is formed with a blocking member projecting toward the frame base;
wherein one of the frame stop walls has an extension length defined as L₁, the other frame stop wall has an extension length defined as L₂, and the two extension lengths satisfy the relation of L₁:L₂=1:1˜3.

2. The bottom rail of claim 1, wherein the mounting aperture corresponds in position to the frame base and extends lengthwise in a left-right direction.

3. The bottom rail of claim 2, wherein each said frame sidewall and the frame stop wall extending therefrom form a junction with a position-limiting recess.

4. A window blind, comprising:
a headrail having a bottom wall, wherein the bottom wall has two through holes, and each of the through holes opens on a top surface and a bottom surface of the bottom wall;
a blind body having a first end mounted on the bottom surface of the bottom wall of the headrail;
a cord reel mounted on the top surface of the bottom wall of the headrail;
two lift cords each having an end fixedly provided at the cord reel and an opposite end that is wound along a predetermined path, is subsequently inserted through the through holes of the headrail and the blind body, and is subsequently fixed to an opposite second end of the blind body by a cord fixing member;
a weight provided at the second end of the blind body; and
the bottom rail of claim 1, wherein the bottom rail is mounted at the second end of the blind body.

5. The window blind of claim 4, wherein the weight mounted at the second end of the blind body and at least one of a plurality of slats or cells of the blind body are mounted into the bottom rail through an opening at either of a left lengthwise end and a right lengthwise end of the bottom rail and are thus received in the receiving space of the bottom rail, with a junction between the at least one slat or cell and the other slats or cells of the blind body exposed through the mounting aperture of the bottom rail.

6. The window blind of claim 5, wherein the at least one slat or cell and the other slats or cells of the blind body are separated by the two frame stop walls of the bottom rail and are located on a top side and a bottom side of the two frame stop walls respectively.

7. The window blind of claim 6, wherein the frame base of the bottom rail has an outer wall mounted with a pull ring.

8. The window blind of claim 4, wherein at least two of a plurality of slats or cells of the blind body are pressed together and are subsequently mounted along with the weight into the bottom rail through an opening at either of a left lengthwise end and a right lengthwise end of the bottom rail such that the weight and the at least two slats or cells of the blind body are received in the receiving space of the bottom rail and are blocked and held in place by the blocking members at the free ends of the two frame stop walls of the bottom rail, with a junction between the at least two slats or cells and the other slats or cells of the blind body exposed through the mounting aperture of the bottom rail.

9. The window blind of claim 8, wherein the at least two slats or cells and the other slats or cells of the blind body are separated by the two frame stop walls of the bottom rail and are located on a top side and a bottom side of the two frame stop walls respectively.

10. The window blind of claim 9, wherein the frame base of the bottom rail has an outer wall mounted with a pull ring.

11. A window blind, comprising:
a headrail having a bottom wall, wherein the bottom wall has two through holes, and each of the through holes opens on a top surface and a bottom surface of the bottom wall;
a blind body having a first end mounted on the bottom surface of the bottom wall of the headrail;
a cord reel mounted on the top surface of the bottom wall of the headrail;
two lift cords each having an end fixedly provided at the cord reel and an opposite end that is wound along a predetermined path, is subsequently inserted through the through holes of the headrail and the blind body, and is subsequently fixed to an opposite second end of the blind body by a cord fixing member;
a weight provided at the second end of the blind body; and
the bottom rail of claim 3, wherein the bottom rail is mounted at the second end of the blind body.

12. The window blind of claim 11, wherein the weight mounted at the second end of the blind body and at least one of a plurality of slats or cells of the blind body are mounted into the bottom rail through an opening at either of a left lengthwise end and a right lengthwise end of the bottom rail and are thus received in the receiving space of the bottom rail, with a junction between the at least one slat or cell and the other slats or cells of the blind body exposed through the mounting aperture of the bottom rail.

13. The window blind of claim 12, wherein the at least one slat or cell and the other slats or cells of the blind body are separated by the two frame stop walls of the bottom rail and are located on a top side and a bottom side of the two frame stop walls respectively.

14. The window blind of claim 13, wherein the frame base of the bottom rail has an outer wall mounted with a pull ring.

15. The window blind of claim 11, wherein at least two of a plurality of slats or cells of the blind body are pressed together and are subsequently mounted along with the weight into the bottom rail through an opening at either of a left lengthwise end and a right lengthwise end of the bottom rail such that the weight and the at least two slats or cells of the blind body are received in the receiving space of the bottom rail and are blocked and held in place by the blocking members at the free ends of the two frame stop walls of the bottom rail, with a junction between the at least two slats or cells and the other slats or cells of the blind body exposed through the mounting aperture of the bottom rail.

16. The window blind of claim 15, wherein the at least two slats or cells and the other slats or cells of the blind body are separated by the two frame stop walls of the bottom rail and are located on a top side and a bottom side of the two frame stop walls respectively.

17. The window blind of claim 16, wherein the frame base of the bottom rail has an outer wall mounted with a pull ring.
